(19) United States
(12) Patent Application Publication
(10) Pub. No.: US 2023/0354730 A1
(43) Pub. Date: Nov. 9, 2023

(54) NOVEL NATURAL APPROACH TO AUTONOMOUS DETECTION AND REMOVAL OF DANDELIONS AND WEEDS WITHOUT USE OF HARMFUL CHEMICALS

(71) Applicant: Hudson Aaron Jantzi, St. Clements (CA)

(72) Inventor: Hudson Aaron Jantzi, St. Clements (CA)

(21) Appl. No.: 17/736,727

(22) Filed: May 4, 2022

(51) Int. Cl. A01B 39/18; A01B 79/00

(52) U.S. Cl. CPC A01B 39/18; A01B 79/005

(57) ABSTRACT

The present invention relates to using electronics, robotics and sensors to trim the dandelion reproductive cycle. The present invention includes a camera sensor to detect, classify, and distinguish unwanted weeds from wanted green grass in a lawn, and removes and collects the unwanted flowers and seeds so they cannot reproduce doing this all autonomously from a battery powered device transversing the user's grass and lawn. The device also includes a geolocation module to keep it inside a set geofence, obstacle avoidance sensors to prevent hitting trees, shrubs, flowerbeds, pets or humans as it is in operation. The device is environmentally friendly and removes the need for nasty herbicide chemicals to be places on the lawn and is completely green as it can be charged via solar panels. Some implementations may call this an environmentally friendly autonomous dandelion detector and remover.

### FIELD OF THE INVENTION

The present disclosure relates to using an autonomous robotic device to detect and selectively remove unwanted weeds from a lawn or garden to maintain and create an aesthetically pleasing lawn without human intervention. The disclosure relates to a robot with detection sensors to detect weeds from the lawn and remove the weeds autonomously to prevent further spread and seeding of new seeds.

### BACKGROUND OF THE INVENTION

Millions of people around the world use harmful chemicals (pesticides and herbicides) to remove harmless weeds, including dandelions, from their lawns for the purpose of lawn vanity. Unfortunately, pesticides and herbicides harm the environment by leaching harmful chemicals into nature, harming plants, wildlife and water systems.

Local laws ban some herbicides on lawns, parks and schools as they are dangerous to humans. Others require a license to discourage the use. Most herbicides used on lawns contain chemicals such as triclopyr, dichlorophenoxyacetic acid, PCPP, MCPA and dicamba which can be very harmful to humans, pets and the environment. Most herbicides kill plants by mimicking growth hormones and tricking plants into a sudden burst of growth that overwhelms the weed to kill it. This method is used in most general use herbicides, including triclopyr, 2 4-D and mecoprop (MCPP).

Due to advances in electronics, robotics, batteries, and IOT technologies an environmentally friendly autonomous weed detection device has been implemented to help solve the concerns people have on weed vanity. This disclosure will allow people to have a green weed free lawn without use of environmentally unfriendly chemicals just by placing the device in this embodiment on the lawn and letting it operate autonomously.

### DESCRIPTION OF THE DRAWINGS

Some implementations of the present disclosure are described with respect to the following figures.

FIG. 1 is a block diagram with an example arrangement of the device that includes a microprocessor unit, camera sensor, drive train, location based circuitry, object avoidance, sensors, according to some implementations of the present disclosure.

FIG. 2 is a flow diagram of a process of parameters to determine the decision making of the present disclosure device. An example implementation determines objectives based on sensor inputs such as if sun is present and temperature is valid and then software algorithm selectively determines if white dandelion head, yellow dandelion or closed dandelion heads are present than behaves differently depending on the stage of dandelion or unwanted weed flower in growth cycle.

FIG. 3 shows some of the possible implementations of the weed remover apparatus mechanisms which would be contained on the present disclosure device.

FIG. 4 is a schematic illustration sample implementation of yard, lawn or garden showing typical obstacles the present disclosure device will need to navigate in its search for unwanted weeds, unwanted dandelions, unwanted invasive species or other unwanted plants to detect and remove.

FIG. 5 is a high level block diagram of an example implementation of an autonomous robotic weed detector and remover showing some of the typical subsystems on the device.

### SUMMARY

The present invention provides a solution to removing unwanted weeds, dandelions (taraxacum officinale), invasive plants and other unwanted plants from a user's lawn or garden. The invention entails a device or apparatus that can autonomously detect and remove unwanted weeds simply by transversing a user's lawn with no or minimal interaction. The device can collect unwanted seeds inside its collection reservoir such as a bin, bag, or otherwise for disposal to prevent reseeds and regrowth of the next generation of plants. Hence, using this device will keep a user's lawn looking green and weed free in an environmentally free way and help eliminate the need for toxic chemicals to be used.

### DETAILED DESCRIPTION OF THE PREFERRED EMBODIMENTS

The present disclosure is directed at the autonomous elimination of weeds from residential, commercial, agriculture, and industrial lawns with use of a battery powered robotic device and plethora of integrated sensors using a weed detector and remover. Said robotic device operates autonomously in a yard, lawn garden and will have the capability to detect and remove unwanted and undesired weeds and invasive species, such as taraxacum officinale(common dandelions), tussilago farfara (coltsfoot), bindweed, cinquefoil, and many other unwanted plants not listed and collect their seeds for proper disposal. Someone may consider this to be called a dandelion detector and remover robot system and apparatus.

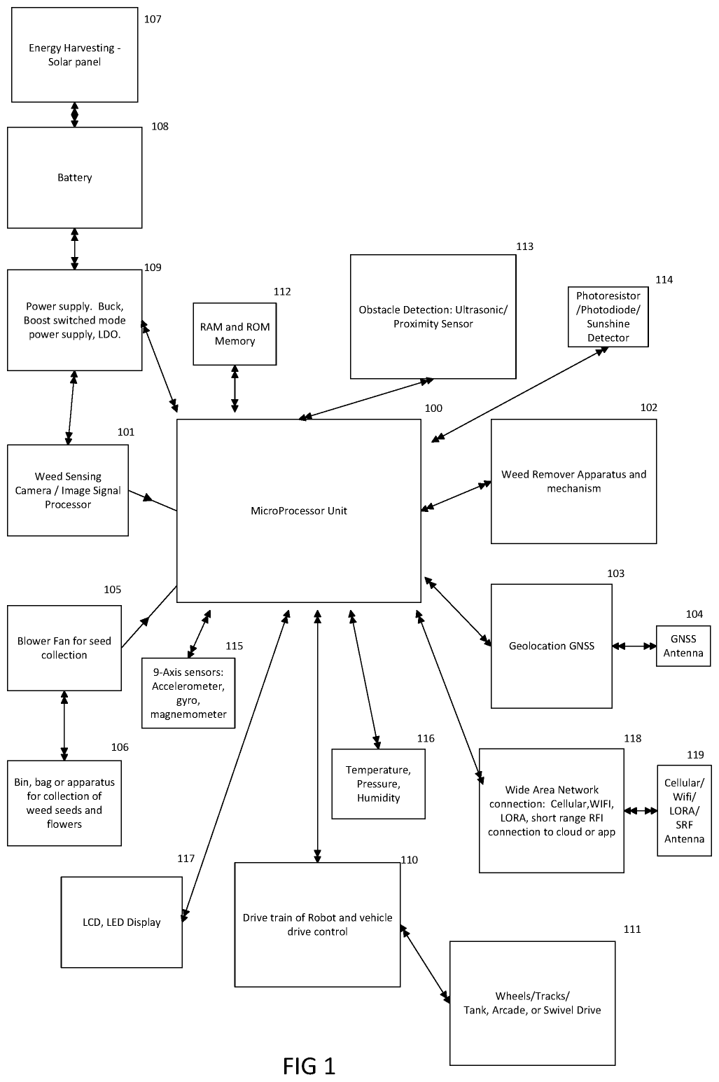

At a high level, the device will remove seeds and flowers from a lawn to prevent growth of future plants from seeds that typically would repopulate across a lawn. FIG. 1 is an example of a weed detector removal apparatus block diagram. The apparatus in this disclosure typically will include electronics as well as mechanical devices. At the heart of the system is a microprocessor unit 100 which can be referenced in FIG. 1. The device also includes software and algorithms which is stored in the host units RAM and ROM memory 112. The device also included a weed sensing optical camera, image signal processor (ISP), CCD sensor, or other equivalent sensor 101 to scan and detect weeds. The device may include a blower fan for seed collection 105 and collection bin, bag or apparatus 106 to collect and dispose of weed seeds. The device will include a weed remover apparatus and mechanism of some kind to kill and remove the weed heads and seed in part or in whole 102. The device will include a drive train 110 with wheels, tracks 111 or equivalent to manoeuvre the device over the lawn. The drive train 110 will be sufficient high enough to allow clearance over the tops of the weeds to allow the weed sensing camera 101 good visibility for unwanted weed detection. The drive train 110 and wheels 111 must be sufficient to manoeuvre and transverse the lawn without getting stuck, however if it does get stuck it will inform the user via the LCD, LED display 117 or the wide area network (WAN) connection 118.

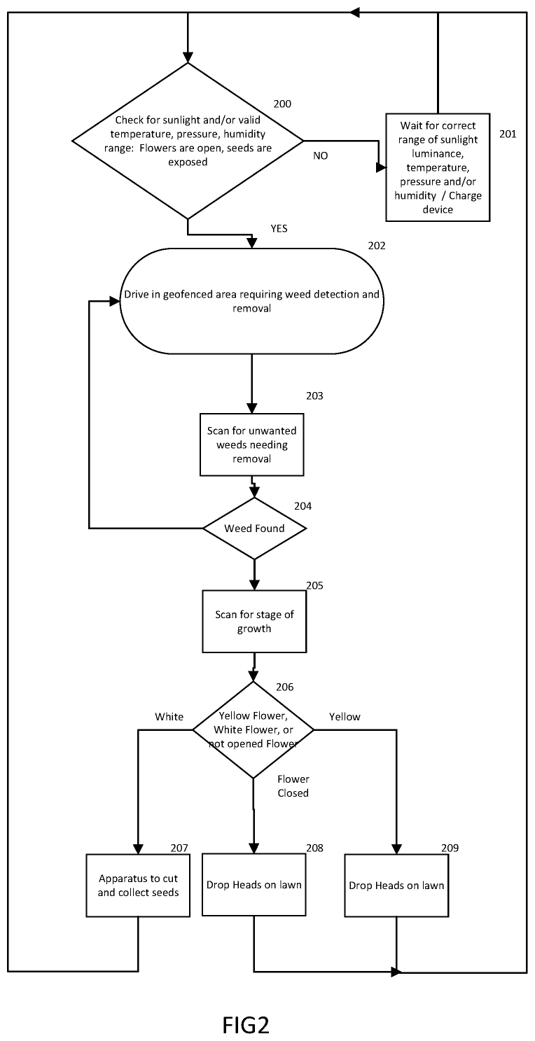

The device may include an ultrasonic, proximity or equivalent sensor 113 to prevent it from running into obstacles on the grass or lawn such as trees, flowerbeds, pets, humans, etc. In some implementations, the device will include a geolocation module or chipset to determine its location which could be GNSS (GPS, GLONASS, Beidou, Galileo, IRNSS, NavIC, QZSS, SBAS, etc), BLE, UWB, LORA, RFID or equivalent 103 which will include some form of patch, inverted F, whip, monopole or equivalent antenna 104. The GNSS antenna may be right hand circular polarized. The device may also include an accelerometer, gyroscope, magnetometer 115 to track its motion using an inertial measurement unit (IMU) for dead reckoning or equivalent. Device will include a photoresistor, photodiode or equivalent sensor to detect light luminance and sunlight 114 and in some implementations will only operate to cut flowering seeds when the light or sunlight is present, hence the flowers are opened and blooming. FIG. 2 describes a possible algorithm flowchart of a possible implementation. Device may also include a screen or display or indicator lights 117 to show operation status, service or maintenance information, or other information useful to the user, which may be in the form of a LCD, LED or equivalent.

Some implementations will also include a connection to the internet, whether it be a 2G, 3G, 4G, or 5G connection 118 to the cloud to display pertinent information and/or also to a cell phone app so owner, operator or maintenance crew can remotely check status. IOT technologies such as LTE cat-M and NB-10T are especially suited to this application which will also include a cellular antenna 119. The device will be completely battery powered with a rechargeable battery 108 and will include power supply circuitry such as buck, boost, buck-boost, boost-buck, LDO circuits. In some implementations an environmentally friendly renewable energy harvesting device 107 such as a solar panel will be included on the device to recharge the battery 108. In other implementations, device could move to a docking station, mapped via the geofence found via the geolocation GNSS circuitry 103 to recharge the battery.

Some implementations will also include a temperature, pressure, humidity sensor 116 to ensure the environmental conditions are optimal for weed removal. For example, if the temperature is too cold it may not be optimal for weed removal or if humidity levels are not correct preference may be to want to wait to perform operation at a different time. For example, if low pressure is present, hence a storm may be on the horizon, may want to wait to operate the device until the pressure improves. This sensor in FIG. 2 can be utilized, when valid temperature, humidity and pressure 200 are checked before operation of the device in the present disclosure. If incorrect sunlight luminance, temperature, pressure, or humidity levels are present, device will wait to operate and in some implementations wait and charge the device 201.

FIG. 2 represents a typical software flow algorithm of the present embodiment. The present disclosure provides a method to remove weeds by allowing the robot weed detector to transverse the lawn geofenced area which requires weed detection and removal 202 scanning for said unwanted weeds which will typically have different flower, leaf, steam structures than the grass and can be differentiated by a image signal processor algorithm depicted by the cameras optical sensors 203.

In this embodiment, a camera sensor 101 is mounted to the robot device which scans the ground and lawn for imperfections in the grass and lawn, recognizes these as weeds 204 and relates this information back to the microprocessor unit 100 which triggers the weed remover apparatus mechanism 102 to turn on and remove the unwanted weed or plant in the lawn.

This embodiment will perform different events based on the camera sensors 101 depiction of the weeds stage of growth, development, maturity and weather it has seeds or no seeds in its flower 205. If no seeds are present it will do a set flow of events as depicted in FIG. 2 208, 209. If seeds are present 207 it will follow a different set of events such as collect, destroy, and remove seeds in any means possible to prevent re-germination and re-seeding of the weed seeds later in the growing season or the following years.

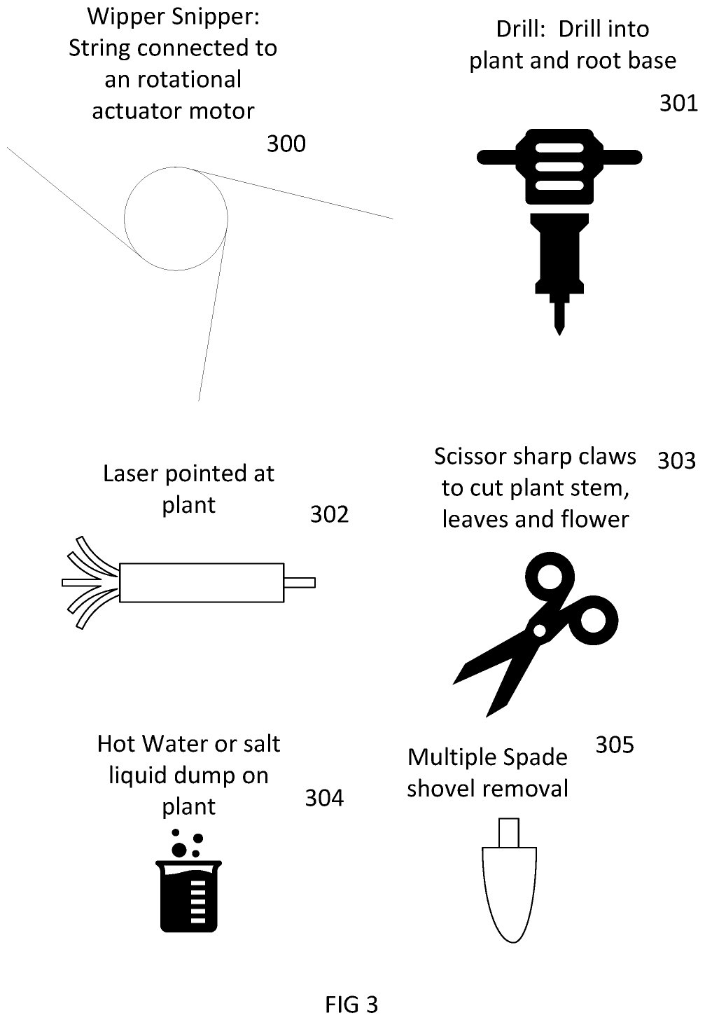

In some implementations, such as the case of a dandelion weed (taraxacum officinale) found 204, the sensors will distinguish between yellow and white dandelion heads and dandelion heads that are about to flower from the wanted green grass and green lawn 206. It will also distinguish the weeds from brown or under watered lawns, not simply green healthy lawns. Examples of this algorithm in the embodiment of FIG. 2 show the deterministic nature of the flow algorithm at a high level. In this implementation, if weed sensor camera 101 detects a yellow dandelion it will simply cut, sever, remove stem and flower from plant by any means necessary as show in FIG. 3. This will help to aesthetically keep the lawn in a beautiful green state which most homeowner's desire.

FIG. 3 depicts the many possible weed remover apparatuses and mechanisms 102 that can be used by this present disclosure weed detector device. This embodiment supports any variety of weed remover apparatus 102 and different implementations will implement differing methods of removal. One such implementation is a whipper snipper, or string attached to a rotational motor or mechanism which spins at high speed to cut the plant 300. Another such implementation is a mechanical drill with a drill bit to spin at the plant stem and/or root species to destroy the plant 301. Another such implementation is a laser device pointed at the plant 302. In other instances, a scissors, or claw with a sharp blade would be used to cut the stem or plant flower 303. In yet another implementation hot water, hot liquid, or salt would be dumped on the plant to damage and destroy it from growing and reproducing 304. Another such implementation would be multiple spades or shovels devices could be used to surround the plant structure, plant root structure on all sides to dig around and remove the stem and root of the unwanted plant 305. Other such methods are possible and this embodiment is not just limited to these above mentioned methods of removal of unwanted weeds and plant species.

Alternatively if weed sensor camera 101 detects a white dandelion, this means that the weed has already flowered and produced seeds which the weed would like to distribute, via wind or other methods, across the lawn to reproduce the species. In this scenario, the apparatus in this embodiment would activate the weed remover apparatus 102 as well as a blower fan for seed collection 105 which will collect the seeds for disposal, removal, etc in a bin or apparatus for collection of the weed seeds and flowers 106. The collection and removal of these seeds from the lawn will prevent re-germination and re-growth of new weed or dandelion seeds in the future and keep the lawn looking green.

In further examples, depending on the weed that requires removal the device will only operate when the sun is out and the weed flowers are blooming. An example of this algorithm is shared in FIG. 2. In these implementations, a photoresistor, photodiode, or sunlight detector 114 to detect sunlight and UV rays would be present on the device.

In some implementations, the robotic apparatus will also autonomously drive and dump the unwanted seeds in certain location defined by user to prevent the seeds from growing the next generation and will drive and move to the location via the GNSS and geolocation module 103, 104 on the device in this embodiment.

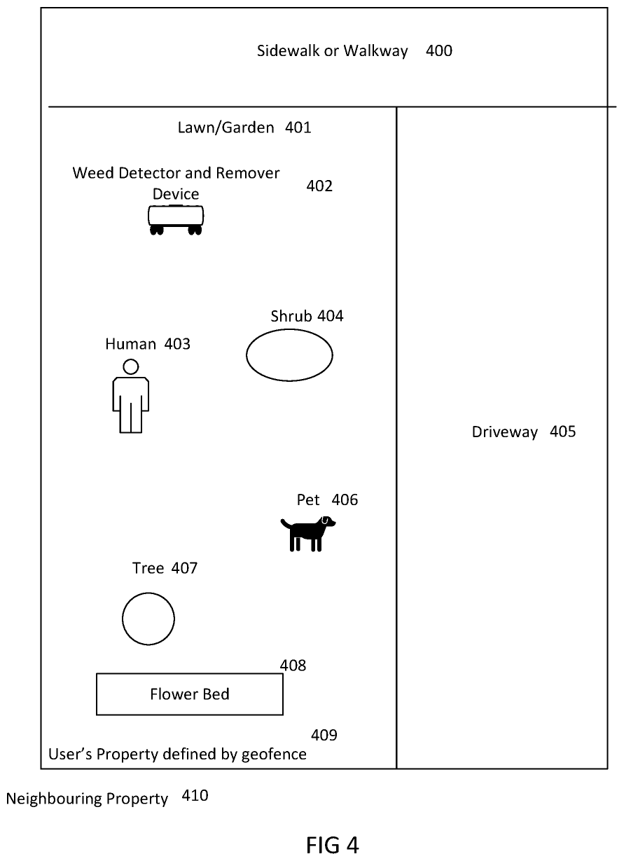

The autonomous battery powered device typically will roam about looking for unwanted weeds, invasive species and the like in a user's lawn, garden or property. A typical example of this is shown in FIG. 4. The referenced weed detector and remover device 402 is shown as it transverses a user's lawn and property. The weed detector and remover device 402, as mentioned already will have an obstacle detection system, being composed of an ultrasonic, proximity sensor, or equivalent circuit which will be used to prevent hitting and colliding with other objects in the lawn/garden 401. The obstacle detection system 113 will prevent hitting both static and dynamic moving objects. Static objects include shrubs 404 and trees 407. Dynamic objects include humans 403 and pets 406. If an incident does occur where the weed detector and remover device is hit it will display such information on the display unit LCD/LED 117 and notify the user via the WAN connection 118, 119 to the cloud and a user's app on their phone, computer or tablet.

The device will transverse only in the defined region defined by the user defined geofences 409 which can be defined by the user to include only the lawn/garden 401, garden grass section of the lawn and would not include flowerbeds 408, sidewalks/walkways 400 or driveways 405, roads or neighbouring properties 410. The device would use its geolocation GNSS module, possibly including L1, L2, L5 GPS, GLONASS, Gaileo, Beiduo, IRNSS, NavIC, QZSS, SBAS, or equivalent system to keep device staying insides it's user defined geofence 103.

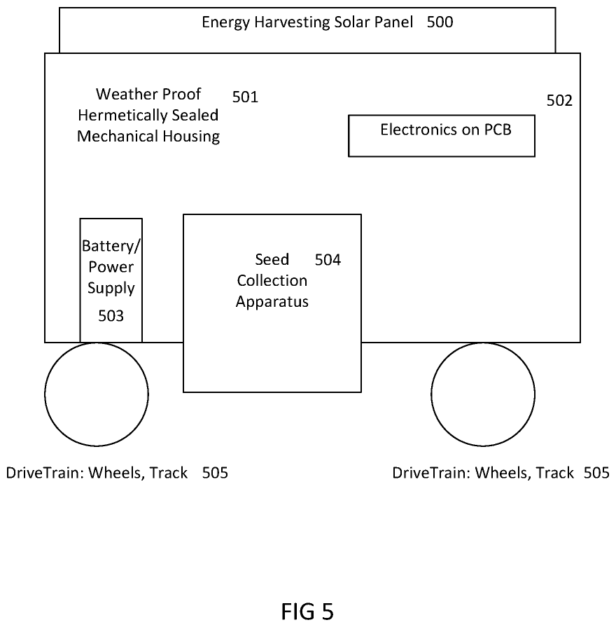

FIG. 5 depicts possible subsystem components of the referenced autonomous robotic weed detector and remover device 402 in this embodiment. The device will include some form of drive train and wheels or track 505 to transverse and move around the lawn. The device will include a rigid or flexible printed circuit board (PCB) 502 holding most all the electronics as described in FIG. 1. The device will also house a battery and power supply 503 to power the unit. The battery and power supply circuit 503 will typically be rechargeable either from a docking station of some kind which can be autonomously found via the geolocation GNSS circuitry 103,104 or be recharged via an energy harvesting system such as a solar panel 500. All of this will be enclosed inside of a hermetically sealed mechanical housing 501 to keep out the elements and keep the unit running properly in any harsh terrain or difficult environmental conditions. The device will also include a seed collection apparatus, bin, bag or collection device 504 to collect the unwanted seeds so they will be disposed of properly and not have any chance of germination to reproduce.

1. An apparatus comprising of an autonomous driven battery powered robotic device, that moves about a user's lawn, garden, grass or equivalent and can sense and remove unwanted weeds such as dandelions or invasive species or equivalent, to help keep a healthy green lawn and garden free from unwanted weeds or invasive species.

2. The apparatus of claim 1, wherein the robotic device comprises of a camera sensor to scan, detect and filter out weeds or invasive species and differentiate them from the grass or lawn.

3. The apparatus of claim 1, wherein the robotic device comprises of some form of weed remover apparatus and mechanism to remove unwanted weeds and invasive species.

4. The apparatus of claim 3 includes a weed seed collection apparatus such as a bin, bag or collection device to gather plant seeds for disposal to prevent re-growth hence preventing the next generation of growth.

5. The collection apparatus of claim 4 can be disposed of autonomously by the device claimed in 1 or by user intervention where user would manually dump and dispose of unwanted seeds, flowers, leaves, and stems.

6. The apparatus of claim 1 contains an obstacle detection sensor or device such as but not limited to an ultrasonic sensor or proximity sensor to prevent it from hitting trees, stones, flowerbeds, shrubs, bushes, sidewalks, driveways, pets, humans or wild animals in the user's lawn yard area.

7. The system of claim 1 would operate differently under different environmental conditions such as sunlight luminance, cloudy or lighting conditions as this would affect weather the weed plant's flower was open or closed. Other environmental conditions that could cause apparatus of claim 1 to behave differently include checking temperature prior to operation to ensure a proper temperature range for use, checking pressure prior to use to ensure correct pressure range to ensure no weather systems are on route and checking humidity to ensure proper humidity range to ensure no rain or moisture prior to operation.

8. The apparatus of claim 1 contains a geolocation service such as GNSS, BLE, short range RF, or equivalent to help it navigate the yard for weed removal and stay in user defined areas such as a user defined geofence.

9. The apparatus of claim 1 would use a rechargeable battery powered via an energy harvesting system such as solar panels or allow it to go back to a docking station autonomously when required for charging within the user defined geofence.

10. A camera system that can be placed on the robotic device that can determine the maturity cycle/life cycle of the weed and act differently using a different procedure and algorithm, depending on the determined lifecycle stage of the flowers, seeds or stems that are present.

11. The system of claim 10 allows for the different algorithms to be acted upon depending on the determination of the life cycle of the weed. For the example of a dandelion head weed, if white dandelion heads are detected it would collect the seed heads in the collection bin, while if a yellow head or closed head is detected it would have a different procedure such as cutting and removing, but not collecting seeds.

12. The apparatus of claim 1 would also be connected to a wide area network (WAN) via a cellular connection or private network relaying status information, metadata and metrics of the apparatus of claim 1 to a user's phone app, computer, or tablet via a cloud infrastructure.
